(19) United States
(12) Patent Application Publication
(10) Pub. No.: US 2026/0326022 A1
(43) Pub. Date: Oct. 22, 2026

(54) MODULARIZED CARBON-CAPTURE SYSTEM

(71) Applicant: Technip Energies France, Nanterre Cedex (FR)

(72) Inventors: Jean-Francois DELPONT, Nanterre Cedex (FR); Isabelle MARTINELLI, Nanterre Cedex (FR); Adrien NADAL, Nanterre Cedex (FR)

(21) Appl. No.: 19/491,140

(22) PCT Filed: Jun. 17, 2024
(86) PCT No.: PCT/IB2024/000306

§ 371 Date: Dec. 8, 2025

(30) Foreign Application Priority Data
Jun. 19, 2023 (FR) FR2306301
Jun. 4, 2024 (FR) FR2405869

(51) Int. Cl. B01D 53/14; B01D 53/62; B01D 53/78

(52) U.S. Cl. CPC B01D 53/1475; B01D 53/62; B01D 53/78; B01D 2257/504; B01D 2258/0283

(57) ABSTRACT

A system for capturing carbon subsequent to an industrial process can include a group of modules configured to be prefabricated remotely from an industrial site, transported to the industrial site, and interconnected together at the industrial site. Each module can include equipment configured to perform one or more subprocesses of a capturing carbon process. Examples of the one or more subprocesses can include a pre-scrubber subprocess, an absorbent reclaiming subprocess, an absorbent regeneration subprocess, a dehydration subprocess, a deoxygenation subprocess, or any combination thereof.

### CROSS-REFERENCE TO RELATED APPLICATION

This claims the benefit of priority to French Provisional Patent Application No. 23 06301, titled “Modularized Carbon Capture System” and filed on Jun. 19, 2023, the entirety of which is hereby incorporated by reference herein.

### TECHNICAL FIELD

The present disclosure relates generally to carbon capture systems for capturing carbon dioxide in post-combustion flue gas downstream of industrial processes. More specifically, but not by way of limitation, this disclosure relates to a carbon-capture system that is formed from one or more modularized components.

### BACKGROUND

Power plants, refineries, natural gas treatment plants, cement works and other industrial facilities often generate carbon dioxide (CO₂) emissions as a byproduct of their primary industrial processes. If the CO₂ emissions are released into the environment, it can have negative environmental consequences. To help mitigate these environmental impacts, carbon capture techniques have been developed. Carbon capture techniques can be used to capture or “scrub” CO₂ from the byproduct emissions. Once captured, the CO₂ can then be stored or used in other processes.

There are two main categories of carbon capture techniques used to reduce such CO₂ in industrial emissions: pre-combustion techniques and post-combustion techniques. Pre-combustion techniques remove CO₂ from industrial process streams before fuels are combusted, for example, to produce sales-quality natural gas with reduced CO₂ content. Post-combustion techniques remove CO₂ from flue gases after fuels have been combusted.

Fuel-based power generation plants are significant post-combustion CO₂ emitters. Fuel-based power plants burn fuels (e.g., gas, coal, municipal waste and/or biomass) to drive a turbine to generate electricity. Burning such fuels generates flue gas containing CO₂ emissions as a byproduct.

Post-combustion carbon capture techniques can be implemented for industrial facilities such as fuel-based power plants by the addition of a carbon capture plant. A carbon capture plant includes a specialized arrangement of equipment that is designed to capture post-combustion CO₂ in the flue gas output from the emitter. Examples of such specialized equipment can include blowers, pumps, vessels, columns, heat exchangers, and filters. The carbon capture plant is connected to the emitter for receiving and processing the emitter flue gas.

### SUMMARY

One example of the present disclosure includes a system for capturing post-combustion carbon dioxide subsequent to an industrial process, the system comprising a plurality of prefabricated modules independently transportable to an industrial site, the plurality of prefabricated modules having equipment interconnectable at the industrial site to, in combination with site-erected equipment, collectively perform a carbon capture process.

In some examples, each module of the plurality of prefabricated modules includes equipment to implement a subprocess or a set of subprocesses selected from a group of subprocesses consisting of: a pre-scrubber subprocess for contaminant abatement and direct contact cooling for flue-gas quenching and saturation; a flue gas pressurization subprocess for increasing a flue gas pressure for further processing in the system; an absorption subprocess for extracting CO₂ from a flue gas by absorption of the CO₂ with an absorbent; an absorbent reclaiming subprocess for removing a degraded absorbent and salts generated by flue gas contaminants; an absorbent stripping subprocess for extracting saturated CO₂ gas from the absorbent; a dehydration subprocess for drying the saturated CO₂ gas; a deoxygenation subprocess for removing O₂ from a CO₂ gas; a compression subprocess for increasing a pressure of the saturated CO₂ gas or dry CO₂ gas for export or liquefaction; and a liquefaction subprocess for liquifying gaseous CO₂.

In some examples, at least one of the subprocesses can be implemented by a combination of a prefabricated module and the site-erected equipment, the prefabricated module being one of the plurality of prefabricated modules.

In some examples, each module of the plurality of prefabricated modules is fabricated to have dimensions of no greater than 18.3 meters (m) in length and 4.9 m in width, to allow for road transportation of the plurality of prefabricated modules by truck.

In some examples, each module includes bottom and top structural frames connected by vertical posts and reinforcement beams, the bottom structural frame being used to support the equipment of the module.

In some examples, each module of the plurality of prefabricated modules is installed at the industrial site to form a linear configuration of a plurality of interconnected modules.

In some examples, each module of the plurality of prefabricated modules has a length that is an integer multiple of a predefined bay size, the plurality of prefabricated modules comprising a one-bay module, a two-bay module, a three-bay module, a four-bay module, or a combination of the foregoing.

In some examples, each module of the plurality of prefabricated modules is individually replaceable and configured to interact other modules of the plurality of prefabricated modules.

In some examples, the plurality of prefabricated modules are vertically stackable to create a multi-level modular configuration.

Another example of the present disclosure includes a method. The method includes receiving, at an industrial site, a plurality of modules that were prefabricated remotely from the industrial site, wherein each module of the plurality of modules includes equipment configured to perform one or more subprocesses of a carbon capture process. The method also includes installing the plurality of modules in a carbon capture system at the industrial site.

In some examples, each module of the plurality of modules is received by vehicle at the industrial site.

In some examples, each module of the plurality of modules is individually replaceable and configured to interact other modules of the plurality of modules.

In some examples, the plurality of modules are received from one or more manufacturing facilities that are remote from the industrial site, and assembled at the industrial site to create at least part of the carbon capture system.

In some examples, the plurality of modules are assembled at the industrial site by lifting from a road vehicle into allocated areas at the industrial site. At least one module of the plurality of modules can be stacked on top of another module of the plurality of modules, to thereby create a multi-level modular configuration.

In some examples, the plurality of modules are interconnected via process pipework, electrical connections, instrumentation connections, and controls connections to form the carbon capture system at the industrial site.

Still another example of the present disclosure includes a system comprising a plurality of prefabricated modules that include equipment affixed to movable platforms for delivery to an industrial site, the equipment being connectable to a carbon capture system to perform subprocesses of a carbon capture process, wherein the plurality of prefabricated modules include at least one module selected from a group consisting of: an absorber wash water loop module, an absorbent reclaiming module, an absorbent regeneration module, a carbon dioxide dehydration module, and a carbon dioxide deoxygenation module.

In some examples, each module of the plurality of prefabricated modules has dedicated piping isolation, in which intra-equipment piping of each module is isolated from other piping of other modules.

In some examples, at least one module of the plurality of prefabricated modules is vertically stackable on top of another module of the plurality of prefabricated modules.

### BRIEF DESCRIPTION OF THE DRAWINGS

FIG. 1 shows a top-down view of an example of a modularized carbon capture system according to some aspects of the present disclosure.

FIGS. 2A-B show an example of a three-bay process module according to some aspects of the present disclosure.

FIGS. 3A-B show an example of a four-bay process module according to some aspects of the present disclosure.

FIGS. 4A-D show examples of a three-bay rack module according to some aspects of the present disclosure.

FIGS. 5A-D show examples of a four-bay rack module according to some aspects of the present disclosure.

FIG. 6 shows an example of stacked modules according to some aspects of the present disclosure.

FIGS. 7A-B show examples of a pre-scrubber wash water loop module according to some aspects of the present disclosure.

FIGS. 8A-B show examples of an absorber wash water loop module according to some aspects of the present disclosure.

FIGS. 9A-B show examples of a lean/rich absorbent loop module according to some aspects of the present disclosure.

FIGS. 10A-B show additional examples of a lean/rich absorbent loop module according to some aspects of the present disclosure.

FIGS. 11A-B show examples of an absorbent reclaiming module according to some aspects of the present disclosure.

FIGS. 12A-B show additional examples of an absorbent reclaiming module according to some aspects of the present disclosure.

FIGS. 13A-B show examples of an absorbent regeneration module according to some aspects of the present disclosure.

FIGS. 14A-B show additional examples of an absorbent regeneration module according to some aspects of the present disclosure.

FIGS. 15A-B show examples of a dehydration module according to some aspects of the present disclosure.

FIG. 16A-B show additional examples of a dehydration module according to some aspects of the present disclosure.

FIGS. 17A-B show examples of a deoxygenation module according to some aspects of the present disclosure.

FIGS. 18A-B show additional examples of a deoxygenation module according to some aspects of the present disclosure.

FIG. 19 shows a flowchart of an example of a process for deploying a modularized carbon-capture system according to some aspects of the present disclosure.

### DETAILED DESCRIPTION

Certain aspects and features of the present disclosure relate to capturing carbon produced from industrial processes, such as combustion processes, using a system that is modularized. An example of such a system is a flexible, integrated suite of post-combustion carbon capture solutions for any type of emitter. In some examples, a system according to this disclosure can capture 50 kilo tons per annum (ktpa) or more of carbon dioxide. For instance, the system may capture 100 kpta, 200 kpta, 300 kpta, 400 kpta, or more of carbon dioxide. The system can be modularized, comprising a plurality of equipment modules that are capable of being connected together at an industrial site thereby forming structural, electrical, and/or fluidic connections therebetween. Each equipment module can be designed and built offsite (e.g., at a manufacturing facility) with an ability to perform a particular function and can be sized to be transported to the site in an already-formed state. For example, each module can be sized such that transportation vehicles, such as trucks, can transport the module to the industrial site via roads.

A modularized system can include prefabricated modules or racks that can be interconnected or otherwise coupled together at the industrial site. There can be dedicated piping isolation per module to facilitate intra-module processes and interconnectedness with other modules. Each module can include sensors or other diagnostic devices that can communicatively couple to a processing device to provide onsite or remote monitoring and control capability.

By using a modularized approach as taught herein, the number of personnel required and personnel time can be minimized for mobilizing the carbon capture system at the site. Modularization can also reduce the impact of maintenance on existing plant operations. For example, each module can be individually accessed and serviced, in some cases in a manner that does not disrupt the otherwise normal operation of the other modules. Additionally, the modules can be stacked vertically (e.g., on top of one another) to reduce the footprint of the carbon capture system. For example, multiple modules may be stacked or otherwise assembled at the industrial site by lifting from a road vehicle into allocated bay areas at the industrial site via crane, winch, or other mechanical handling equipment. Stacked modules can be connected by ladders or stairs to allow for easy access to the modularized equipment. Further, the design of the modules can be standardized, which can reduce the typical project design schedule, increase project execution certainty, and facilitate accelerated delivery of modules to the industrial site.

In some cases, a carbon capture system can include over fifty pieces of equipment. This equipment can be included in multiple modules that can each perform one or more individual functions or sub-processes collectively performed as part of the overall carbon capture process performed by the assembled system on-site. The subprocesses may generally be categorized, for example, as pre-treatment subprocesses, treatment subprocesses, compression subprocesses, and other subprocesses. Examples of the pre-treatment subprocesses can include caustic injection and pre-treatment scrubbing. Examples of the treatment subprocesses can include absorption, absorbent reclaiming, absorbent regeneration, and absorbent storage. Examples of compression subprocesses can include low-pressure compression (LP), dehydration, deoxygenation, and high-pressure (HP) compression. Various subprocesses can be arranged within the modular units, or across a combination of modular units and site-erected equipment, depending on the implementation.

In some examples, each function included in each subprocess can be implemented in its own module of the overall system or in multiple modules stacked one on top of the other. In other examples, two or more functions are implemented in a module of the overall system and other functions may be implemented in their own modules. Any number of modules may be included that can perform the following functions, individually or in groups of modules: pre-scrubber wash water loop, absorber wash water loop, absorbent reclaiming processes, lean/rich absorbent loops, multiple absorbent regeneration processes to strip carbon dioxide from absorbent and to regenerate absorbent, multiple carbon dioxide dehydration processes to remove water from carbon dioxide, and multiple carbon dioxide deoxygenation processes to remove oxygen from the carbon dioxide. Other subprocesses can be used as well. Each individual module can include physical equipment that is configured to perform one of the subprocesses or multiple subprocesses, but not all of the subprocesses.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

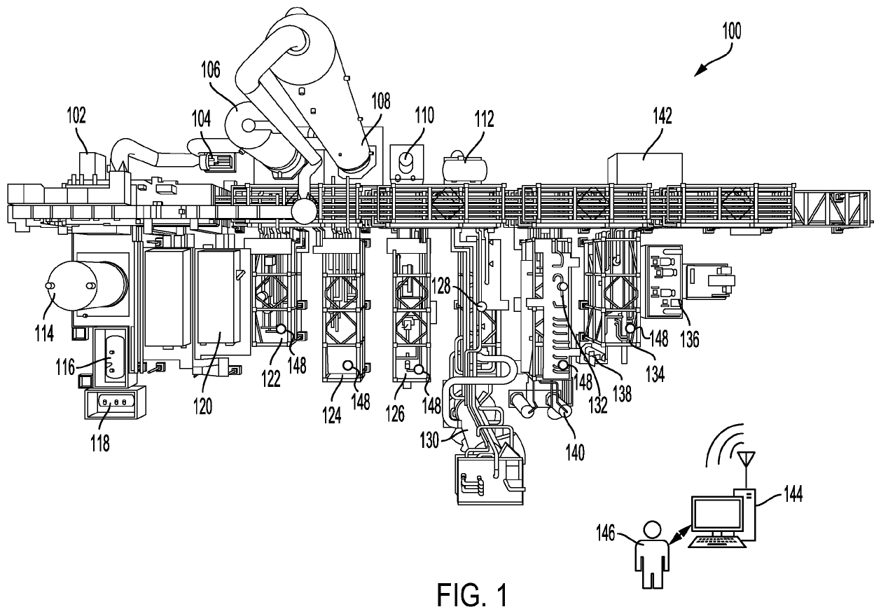

FIG. 1 shows a top-down view of an example of a modularized carbon-capture system 100 according to some aspects of the present disclosure. The carbon capture system 100 can be assembled at an industrial site at least in part from prefabricated modules. The prefabricated modules may include equipment that, when the modules are so assembled, collectively performs a carbon capture process, such as for reducing a level of carbon dioxide in flue gas emitted by an emitter.

One example of such an emitter is a power plant. A power plant is an industrial facility that includes the physical infrastructure for generating large-scale electrical power (e.g., for a power grid). Power plants can include equipment for converting fossil fuels into electrical power. For example, a power plant can include a combustor for combusting fossil fuels, such as gas or coal. This combustion can generate a flue gas that can drive a turbine, such as a gas turbine. The flue gas can drive the turbine by rotating blades of the turbine as the flue gas passes through the blades. Because the blades are connected to a shaft, the shaft can also rotate as the blades rotate. The shaft can be connected to an electric generator, which can convert the mechanical rotation of the shaft into electric power. Power plants can also include other equipment, such as condensers and compressors. Power plants are just one type of emitter that can generate flue gas, but other types of emitters may also generate flue gas.

An emitter can be coupled to a carbon capture system 100 to process the flue gas. The emitter can be coupled to the carbon capture system 100 by ducts and piping. At the carbon capture system 100, the flue gas is processed to extract CO₂ and optionally other byproducts from the flue gas. When the flue gas enters the carbon capture system 100, it may be more than 25% CO₂. After going through the carbon capture process, the flue gas may be less than 2% CO₂.

The carbon capture system 100 can include a configuration of equipment designed to remove the CO₂ from the flue gas. Examples of the equipment can include a caustic injection package 102. The caustic injection package 102 can be configured to neutralize acids in the flue gas to reduce acid corrosion. The caustic injection package 102 can then provide the flue gas to a booster fan 104, which can increase a pressure level of the flue gas before transmitting it to a pre-treatment scrubber 106. The pre-treatment scrubber 106 can be configured to capture residual sulfur dioxide (SO₂) and particulates in the flue gas. The pre-treatment scrubber 106 can then transmit the pre-scrubbed flue gas to an absorber 108.

The absorber 108 can transport the flue gas through a solution that contains amines, which is also referred to herein as an amine solution. The CO₂ in the flue gas can bind with the amines to create carbon-reduced (e.g., carbon-free) flue gas. The carbon-reduced flue gas can be vented from the absorber 108 as exhaust gas. After binding to the CO₂, the amine solution can be transmitted to a stripper 130. The high temperatures can separate the CO₂ from the amine, thereby producing a CO₂ stream that is relatively pure. This stream may be referred to herein as a CO₂ rich gas. The amine solution can then be returned to the absorber 108 for reuse. The CO₂ rich gas can continue to a compressor 136, dryers, de-oxygenation, and liquefaction, which can turn it into a fluid. The fluid can be piped or shipped to its final destination, for example to be sold or buried safely underground.

Other equipment may also be involved in the carbon capture process. For example, the carbon capture system 100 can include an absorbent filtration unit 110, a relief knockout drum 112, a lean absorbent tank 114, E&I shelters 120, an absorbent drain tank 116, a glycol drain tank 118, an oxygen reactor 138, dryers 140, a hydrogen bottle skid 142, or any combination of these. The absorbent filtration unit 110 can be configured to filter particulates from an absorbent, such as the amine solution used by the absorber 108. The relief knockout drum 112 can be configured to remove water vapors and oil from the gas. The lean absorbent tank 114 can be configured to store lean absorbent solution. The Electrical and Instrumentation (E&I) shelters can be configured to house and protect control system and electrical distribution. The absorbent drain tank 116 can be configured to house the absorbent. The glycol drain tank 118 can be configured to house a glycol solvent used with the absorbent. The oxygen reactor 138 can be configured to remove oxygen from CO₂ through chemical reactions. The dryers 140 can be configured to separate compressed CO₂ from water vapor. The hydrogen bottle skid 142 can be configured to capture a hydrogen byproduct. These components may be interconnected to further circulate, treat, and store fluids (e.g., the amine solution and flue gas) in the carbon capture system 100.

The above equipment and/or other equipment of the carbon capture system 100 can be provided on prefabricated, individually transportable modules. For example, the carbon capture system 100 can include a flue gas pre-treatment module 122, a CO₂ absorbent regeneration module 124, an absorbent reclaiming module 126, a CO₂ stripping module 128, a CO₂ drying module 132, a CO₂ deoxygenation module 134, or any combination of these, that may be individually transported and then assembled directly or indirectly to each other onsite. Each module can be configured to perform a subprocess of an overall carbon capture process.

The modules can be prefabricated at one or more manufacturing facilities that are remote from the industrial site and brought to the industrial site by one or more vehicles (e.g., by truck, train, boat, and/or airplane) for installation in the carbon capture system 100. To facilitate transportation of the modules, each module can have its own platform and structural frame to which the equipment is affixed to allow for easy transport of the module and/or for interconnecting the modules on-site via structural connections between the frames of the modules. The structural frame may be made from metal, plastic, composite, or any other structural material. Each module can include bottom and a top horizontal structural frames connected by vertical posts and reinforcement beams. The overall structural assembly can be sized to support dead loads, lifting and transportation loads and loads in operation. The bottom structural frame can also support the equipment and piping. In some examples, the modules may be fabricated to have dimensions no greater than a maximum of 18.3 meters (m) in length, 4.9 m in width, and 4.5 m above special truck trailers, which may allow for road transportation by special construction logistics vehicles.

Each module can be installed at the industrial site and thereby form a linear configuration of a plurality of interconnected modules. The modules can be interconnected via process pipework, electrical connections, instrumentation connections, and control connections to form a complete carbon capture system at the industrial site. The physical interconnections between modules can include direct structural interconnections between adjacent modules, which may in turn provide electrical connections and/or fluidic connections between modules. For example, a structural interconnection between adjacent modules can at least provide structural stability and a desired arrangement, such as to achieve a compact or efficient arrangement, to the as-formed system. Performing the structural interconnections between modules may also cause the electrical and/or fluidic connections to be made. For example, modules to be connected may include electrical connections and/or fluidic connections arranged on the modules such that physically connecting two modules causes the electrical and/or fluid connections to convey electrical power or signal information between modules as well as convey fluids (e.g., process gases) between modules.

Thus, in one or more examples, each module can be designed to be easily “plugged in” to the carbon capture system 100 at the industrial site. For example, each module can have its own set of pre-connected equipment that collectively begins at one or more input connections and collectively ends at one or more output connections. These input/output connections can be used to easily connect the module to other modules and equipment at the industrial site, without having to also configure the interconnections between the pieces of equipment on a given module at the industrial site.

In some examples, the modules can be sized and shaped to fit into available spaces at the industrial site. For instance, the modules can have a generally rectangular shape (e.g., a rectangular prism shape) designed to fit into a correspondingly shaped space at the industrial site. In some examples, a module can be between 12 meters (m) and 21 m in length, between 4 m and 6 m in width, and between 5 m and 10 m in height. Differently sized modules may be designed to fit within predesignated spaces onsite. In some examples, each module can have a length that is an integer multiple of a predefined bay size, to thereby produce two-bay modules, three-bay modules, four-bay modules, etc., as described in greater detail later on.

The disclosed modularity aspects are useful not only for assembling the system initially, but also for individually replacing modules. Thus, one or more module of the assembled system may be individually replaceable by de-coupling the current module from the system, thus separating the physical (including any electrical and/or fluidic) connections therebetween, and replacing that module with another module of the same design, or another design that is physically compatible with the system. The design of each module can also facilitate ease of access for operational maintenance and servicing.

In addition to the equipment itself, in some examples the modules can each include other components to facilitate the operation and monitoring of the equipment. For example, a module may include an electrical panel with circuit breakers to control power flow to one or more electromechanical pieces of equipment onboard the module, such as a pump or heat exchanger. The electrical panel can be pre-installed on the module prior to the module being delivered to the industrial site.

As another example, a module can include one or more sensors schematically indicated at 148 at an arbitrary location (but may be anywhere within the respective module) for monitoring the operation of the equipment onboard the module. The sensors 148 can be pre-installed on the module prior to the module being delivered to the industrial site. Examples of the sensors 148 can include temperature sensors, humidity sensors, accelerometers, gyroscopes, inclinometers, fluid flow sensors, pressure sensors, strain gauges, and optical sensors. The sensors 148 can be communicatively coupled to a computing device 144 via a wired or wireless connection. For example, the sensors 148 can be coupled to the computing device 144 via one or more networks, such as a local area network or the Internet. The computing device 144 can receive the sensor data from the sensors 148 and output the sensor data to a user 146. This may aid the user in monitoring the equipment on the module. Additionally or alternatively, the computing device 144 can analyze the sensor data to detect functional anomalies (e.g., equipment failures) associated with the module. The computing device 144 may use one or more trained machine-learning models to detect such functional anomalies based on the sensor data. In response to detecting a functional anomaly associated with the module based on the sensor data, the computing device 144 can notify the user 146 of the functional anomaly. For example, the computing device 144 can transmit an alert to the user 146 about the functional anomaly.

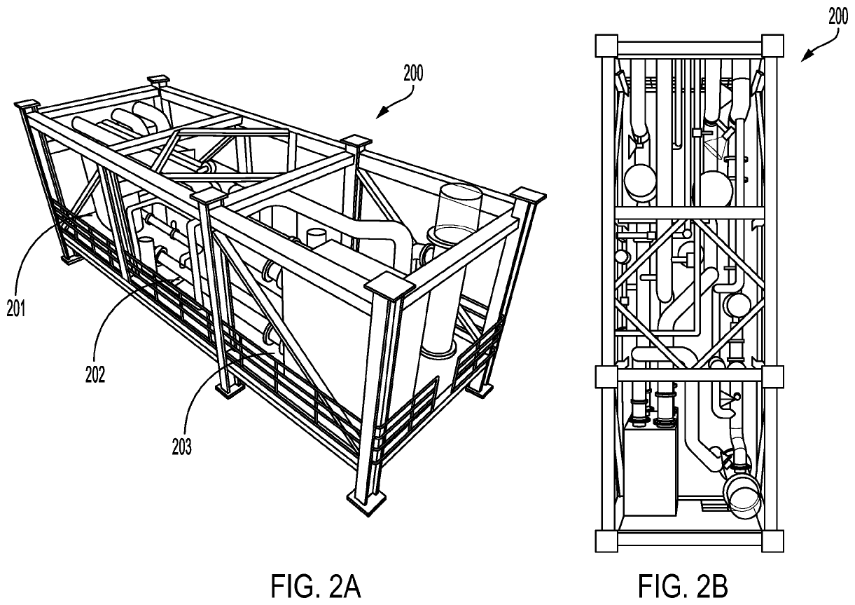

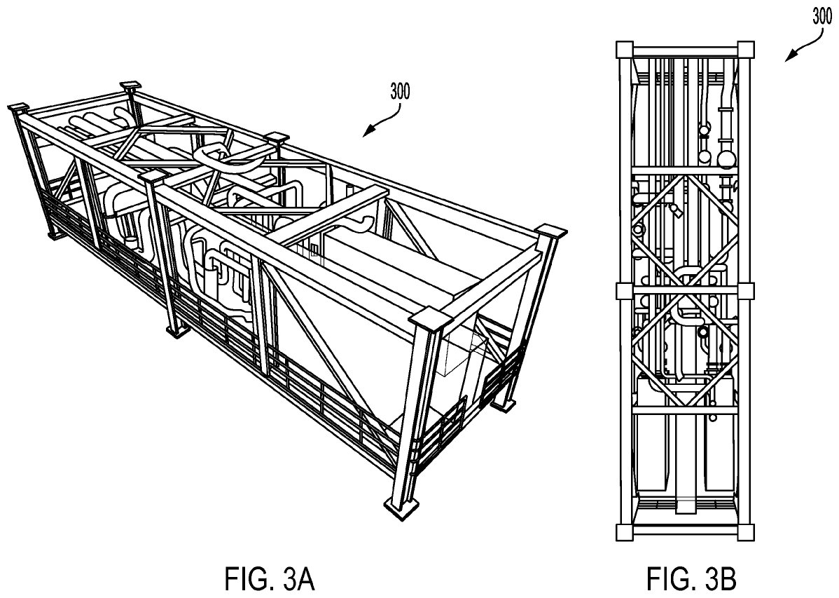

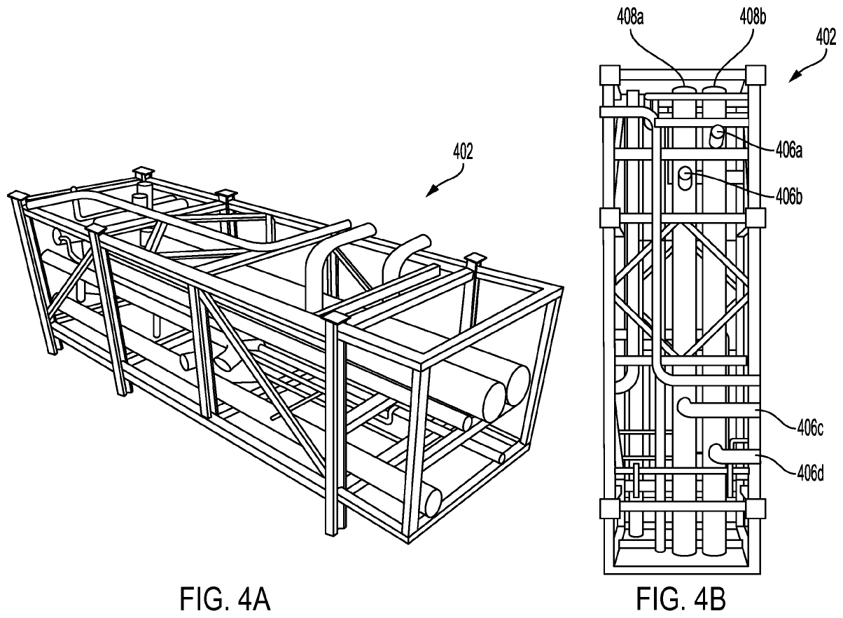

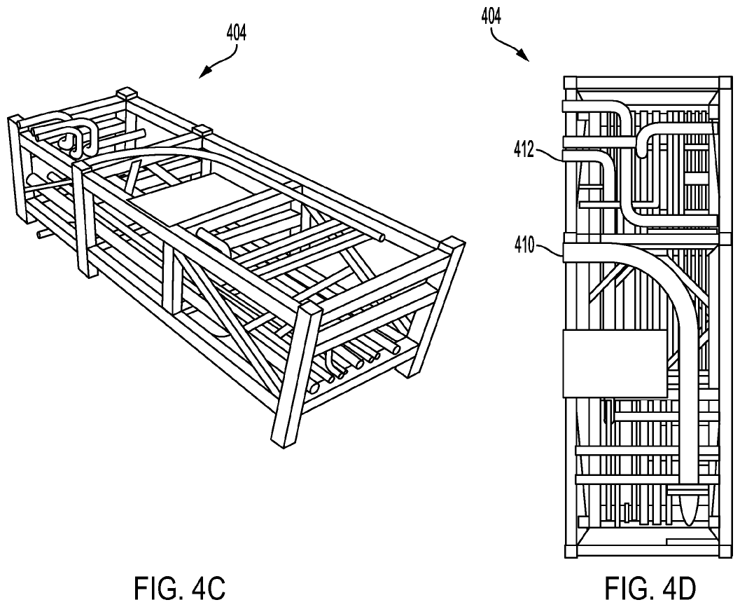

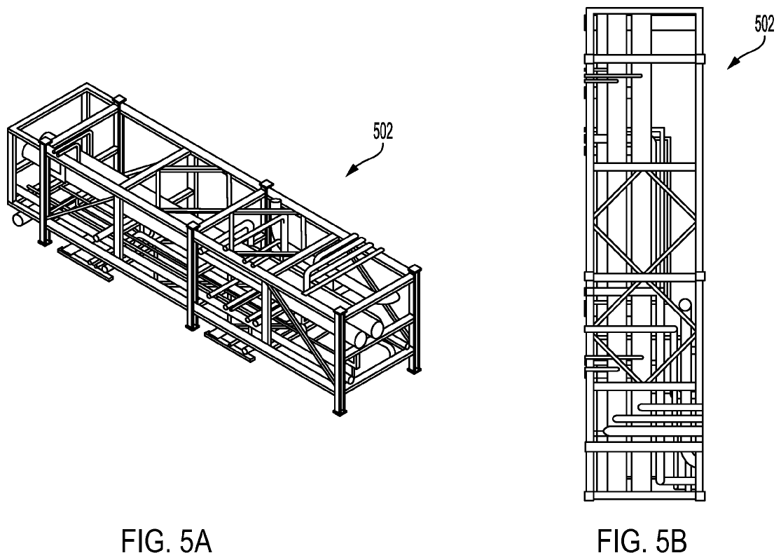

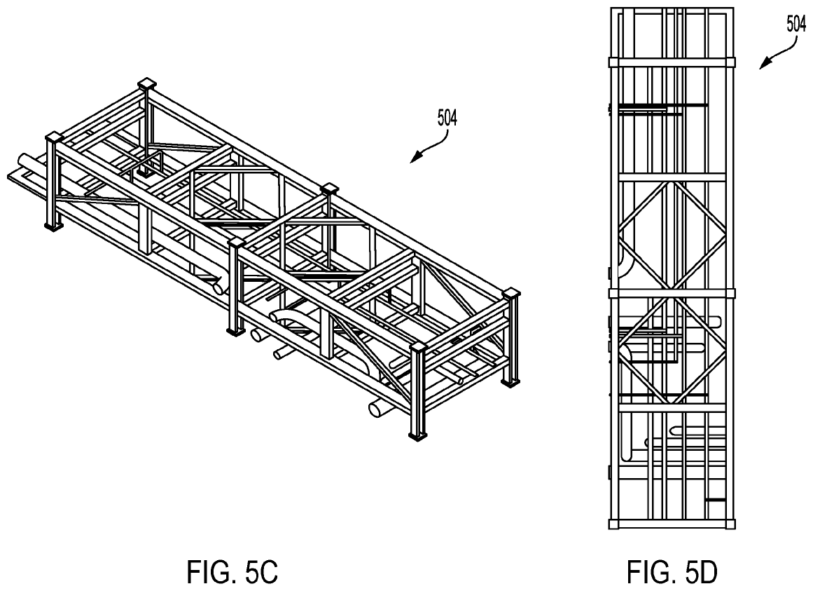

In some examples, there can be different classes of modules. For example, there can be process modules and rack modules. Process modules can include process equipment. In contrast, rack modules may only include interconnection piping and cables (and not process equipment). Rack modules may be useful for establishing connections between process modules. More details about process modules will now be described with respect to FIGS. 2-3. Rack modules are described in greater detail later on with respect to FIGS. 4-5.

Referring now to FIGS. 2A-B, shown is an example of two views of a three-bay process module 200 according to some aspects of the present disclosure. The two views include a perspective view in FIG. 2A and a top-down view in FIG. 2B. The module 200 includes a frame structurally defining three bays 201, 202, 203. The carbon capture equipment or components in this three-bay module 200 may traverse multiple bays of the three-bay module 200. For example, whereas some equipment or components may be sized to fit a single bay and be assembled within a single-bay module, a multi-bay module like the three-bay module 200 of FIG. 2A may provide more space to support the equipment or components if they are too large to fit within a single bay.

In some configurations, the modules each include a structural frame sufficient for the modules to be freestanding, without being received into an external rack structure. Such free-standing modules can be optionally arranged in a vertically-stacked configuration as further described in examples below. In other configurations, a rack structure may be provided defining multiple bays, and the modules may be sized to be received within corresponding bays of the rack structure.

Whether or not a separate rack structure is provided, a modular system according to this disclosure may include predefined bay dimensions that modules may be designed around. Thus, each module may be designed to have some whole-number (i.e., integer) multiple of a particular bay dimension. For example, a carbon capture system may have one or more one-bay modules, two-bay modules, three-bay modules, four-bay modules, or some combination of different sized modules. A two-bay module, for instance, may be twice the length or twice the height (depending on orientation) of the corresponding bay length or height, as the case may be. For example, predefined bay dimensions may be 4.6 m long, 4.9 m wide, and 5.3 m high. Accordingly, the three-bay module 200 in this example can be sized to take up three bays of equipment space at an industrial site, which results in corresponding module dimensions of 13.8 m long (approximately three times the individual bay length of 4.6 m), 4.9 m wide, and 5.3 m in height. The module 200 may weigh 40-70 tons (T). The module 200 can be configured for transportation by land, sea, or air, for example.

In some examples, the module 200 can include a structural frame comprising any structural material (e.g., metal, plastic, composite, and so forth) and a platform on which equipment can be interconnected. The equipment supported on the structural frame can be configured to perform a subprocess of a carbon capture process. The module 200 can be stackable, such that two or more of the modules can be vertically stacked on top of one another to create a multi-level configuration, such as a two-level configuration or higher. Stairs or ladders can be attached to the stacked modules to allow for easy access to the levels.

FIGS. 3A-B show an example of two views of a four-bay process module 300 according to some aspects of the present disclosure. The two views include a perspective view in FIG. 3A and a top-down view in FIG. 3B. The module 300 can be sized to take up four bays of equipment space at an industrial site. For example, the module 300 can be ~18.3 m long (e.g., approximately four times the individual bay length of 4.6 m), 4.9 m wide, and 5.3 m in height. The module 300 may weigh 60-160 T. The module 400 can be configured for transportation by land or water ways (river, sea).

In some examples, the module 300 can include a frame and a platform on which equipment can be interconnected. The equipment can be configured to perform a subprocess of a carbon capture process. The module 300 can be stackable, such that two or more of the modules can be stacked on top of one another to create a multi-level configuration. Stairs or ladders can be attached to the stacked modules to allow for easy access to the levels.

FIGS. 4A-D show examples of a three-bay rack module according to some aspects of the present disclosure. FIGS. 4A-B show two views of one type of three-bay rack module 402, whereas FIGS. 4C-D show two views of another type of three-bay rack module 404. The module 402 in FIGS. 4A-4B is larger in size than the module 404 in FIGS. 4C-4D, but both rack modules 402, 404 can be sized to take up three bays of equipment space at an industrial site. For example, the module 402 in FIGS. 4A-4B can be 13.8 m long, 4.9 m wide, and 5.3 m in height. The other module 404 in FIGS. 4C-4D can be 13.8 m long, 4.9 m wide, and 3.8 m in height. Thus, the module 402 in FIGS. 4A-B can be taller than the other module 402 in FIGS. 4C-4D, yet both three-bay modules 402, 404 can be sized to fit within (even if not completely filling the volume of) three bays of space defined for a particular system. The modules 402-404 can be configured for transportation by land, sea, or air.

In some examples, the modules 402-404 can be rack modules. They can each include a frame and a platform on which piping and other equipment can be affixed for interconnection with other modules. The modules 402-404 can be stackable, such that two or more of the modules can be stacked on top of one another to create a multi-level configuration. Stairs or ladders, which are also optionally modular and replaceable, can be attached to the stacked modules to allow for easy access to the levels.

The modules described herein may each have dedicated piping isolation, such that the intra-equipment piping of a given module is isolated from the intra-equipment piping and from interconnecting lines of other modules. Additionally, the modules can each have one or more inlets and one or more outlets for connecting (e.g., creating fluidic or electrical connections from) the module to other modules and/or equipment of a carbon capture system. For example, module 402 can have inlets 406a-d and outlets 408a-b. As another example, module 404 can have an inlet 410 and an outlet 412. The inlets of a given module can serve as inputs to the module as a whole, and the outlets of a given module may serve as outputs from the module as a whole.

FIGS. 5A-D show an example of a four-bay rack module according to some aspects of the present disclosure. FIGS. 5A-B show two views of one kind of four-bay rack module 502. FIGS. 5C-D show two views of another kind of four-bay rack module 504. The module 502 in FIGS. 5A-5B is larger in size than the other module 504 in FIGS. 5C-5D, but both rack modules 502-504 can be sized to take up four bays of equipment space at an industrial site. For example, the module 502 in FIGS. 5A-5B can be 20.3 m long, 4.9 m wide, and 5.3 m in height. The other module 502 in FIGS. 5C-5D can be 20.3 m long, 4.9 m wide, and 3.8 m in height. Thus, the module 502 in FIGS. 5A-5B can be taller than the other module 504 in FIGS. 50-5D. The modules 502-504 can again be configured for transportation by land, sea, or air.

In some examples, the modules 502-504 can each include a frame and a platform on which equipment can be interconnected. The equipment can be configured to perform a subprocess of a carbon capture process. The modules 502-504 can be stackable, such that two or more of the modules can be stacked on top of one another to create a multi-level configuration. Stairs or ladders can be attached to the stacked modules to allow for easy access to the levels.

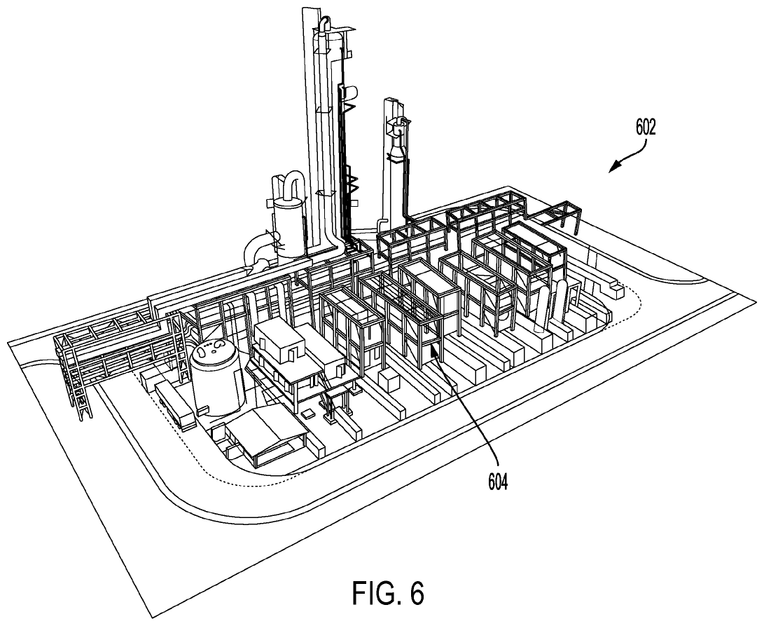

One example of stacked modules is shown in FIG. 6. As shown, two modules 604 can be stacked on top of one another at an industrial site 602. The modules 604 may be stacked using a crane, forklift, or other lifting equipment. After they are stacked and affixed in position, the equipment on the modules 604 can then be interconnected with one another to facilitate one or more subprocesses of a carbon capture process. In some cases, there may be additional modules stacked on top to produce a three-level configuration, a four-level configuration, or higher.

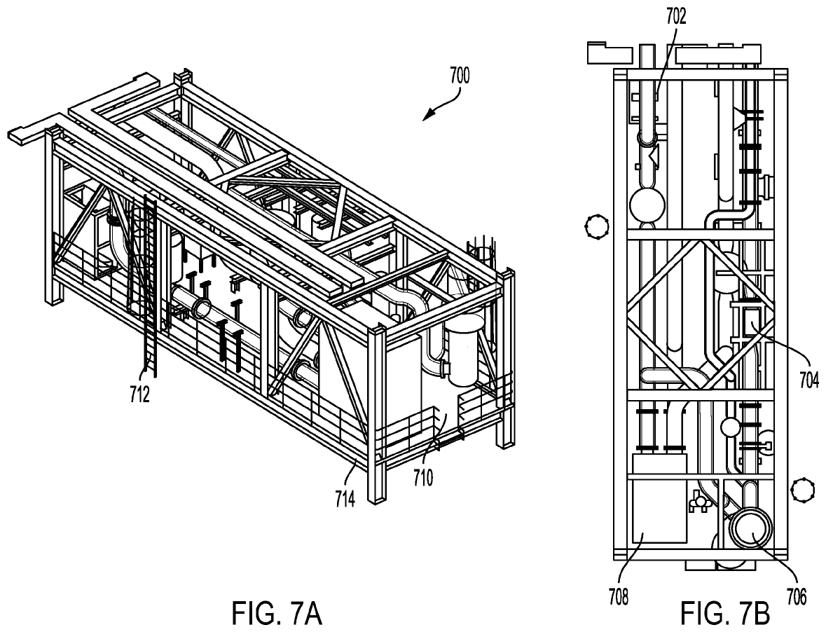

FIGS. 7-18 show examples of specific modules usable in a carbon capture system according to some aspects of the present disclosure. Each of these specific modules will now be described in turn.

Referring now to FIGS. 7A-B, shown are two views of an example of a pre-scrubber wash water loop module 700 according to some aspects of the present disclosure. FIG. 7A shows a perspective view of the module 700 and FIG. 7B shows a top-down view of the module 700. The module 700 can include a junction box 702, a pre-scrubber pump 704, a pre-scrubber filter 706, and a pre-scrubber water cooler 708. This equipment can be interconnected by piping prior to the module 700 arriving at an installation site. In other examples, the module 700 may include more, less, or different equipment than is shown.

The equipment can be attached to a platform 710 and/or surrounded by a structural support frame 714, such as a steel structure. In some examples, the module 700 may include one or more ladders, such as ladder 712, and one or more staircases. This can facilitate access to upper portions of the module 700 by workers, for example for maintenance or installation purposes. The ladders or staircases can may also facilitate access to another module when the modules are in a stacked configuration. In some examples, the module 700 can be 13.8 m in length, 4.9 m in width, 5.3 m in height, and 65 T in weight. In other examples, the module 700 may have other dimensions or weights.

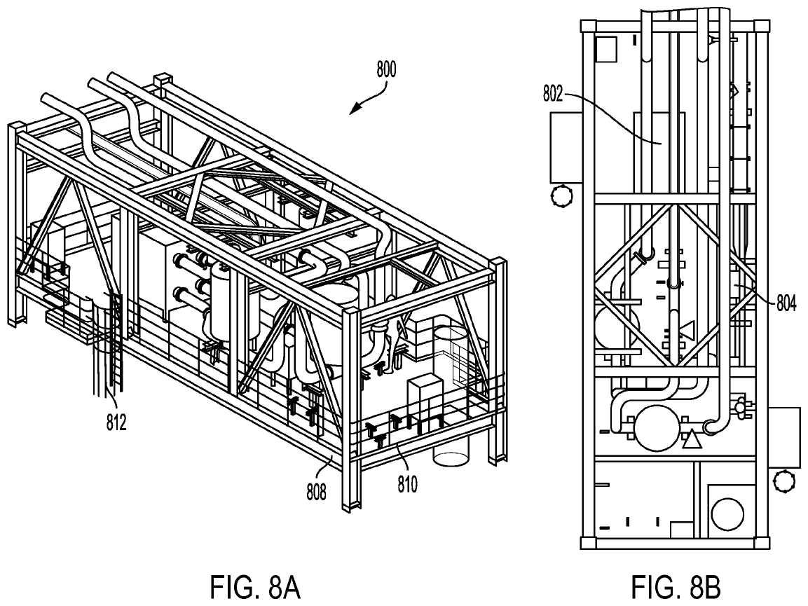

FIGS. 8A-B show two views of an example of an absorber wash water loop module 800 according to some aspects of the present disclosure. FIG. 8A shows a perspective view of the module 800 and FIG. 8B shows a top-down view of the module 800. The module 800 can include a water wash cooler 802 and a water wash pump 804. This equipment can be interconnected by piping prior to the module 800 arriving at an installation site. In other examples, the module 800 may include more, less, or different equipment than is shown.

The equipment can be attached to a platform 810 and/or surrounded by a structural support frame 808, such as a steel structure. In some examples, the module 800 may include one or more ladders, such as ladder 812, and one or more staircases. This can facilitate access to upper portions of the module 800 by workers, for example for maintenance or installation purposes. The ladders or staircases can may also facilitate access to another module when the modules are in a stacked configuration. In some examples, the module 800 can be 13.8 m in length, 4.9 m in width, 5.3 m in height, and 60 T in weight. In other examples, the module 800 may have other dimensions or weights.

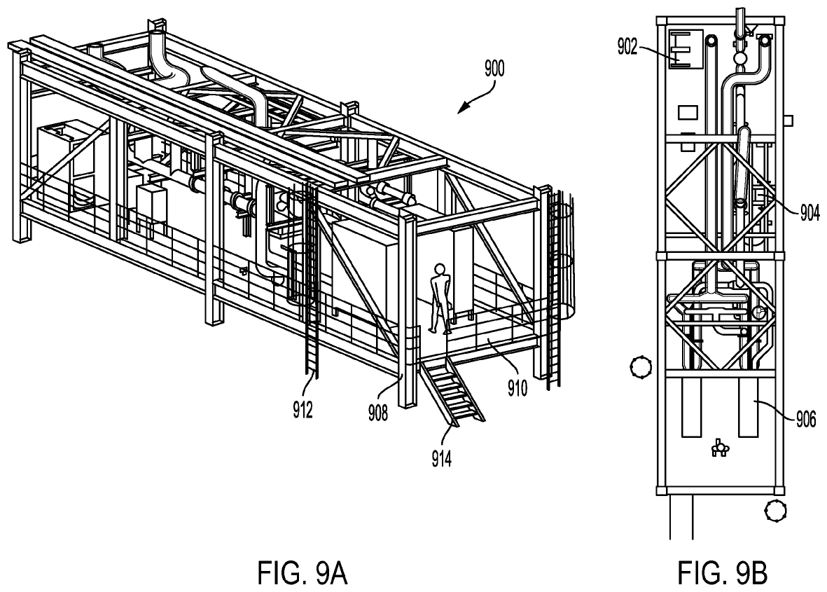

FIGS. 9A-B show two views of an example of a lean/rich absorbent loop module 900 according to some aspects of the present disclosure. FIG. 9A shows a perspective view of the module 900 and FIG. 9B shows a top-down view of the module 900. The module 900 can include a junction box 902, a rich absorbent pump 904, and a lean/rich absorbent exchanger 906. This equipment can be interconnected by piping prior to the module 900 arriving at an installation site. In other examples, the module 900 may include more, less, or different equipment than is shown.

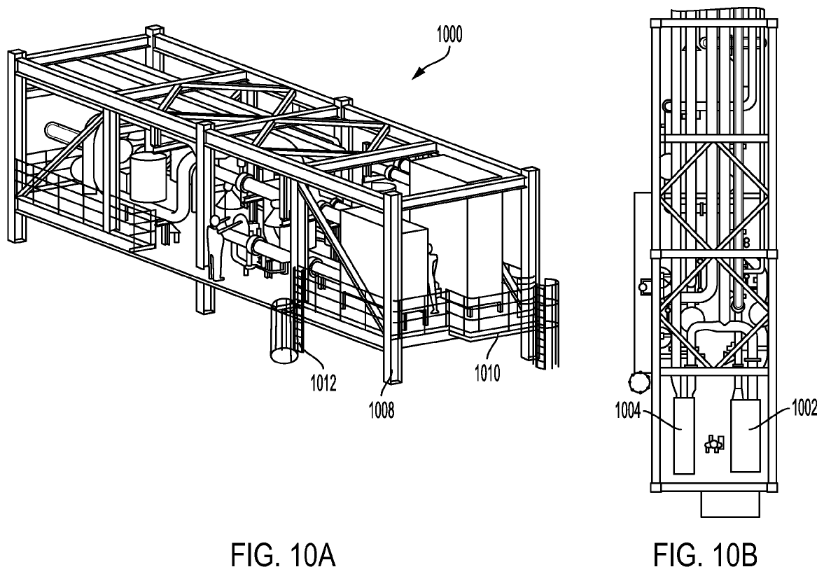

The equipment can be attached to a platform 910 and/or surrounded by a structural support frame 908, such as a steel structure. In some examples, the module 900 may include one or more ladders, such as ladder 912, and one or more staircases, such as staircase 914. This can facilitate access to upper portions of the module 900 by workers, for example for maintenance or installation purposes. The ladders or staircases can may also facilitate access to another module, such as module 1000 of FIG. 10, when the modules are in a stacked configuration. In some examples, the module 900 can be 18.3 m in length, 4.9 m in width, 5.3 m in height, and 97.3 T in weight. In other examples, the module 900 may have other dimensions or weights.

FIGS. 10A-B show two views of another example of a lean/rich absorbent loop module 1000 according to some aspects of the present disclosure. FIG. 10A shows a perspective view of the module 1000 and FIG. 10B shows a top-down view of the module 1000. The module 1000 can include a lean absorbent cooler 1002 and a CO₂ absorber intercooler 1004. This equipment can be interconnected by piping prior to the module 1000 arriving at an installation site. In other examples, the module 1000 may include more, less, or different equipment than is shown.

The equipment can be attached to a platform 1010 and/or surrounded by a structural support frame 1008, such as a steel structure. In some examples, the module 1000 may include one or more ladders, such as ladder 1012, and one or more staircases. This can facilitate access to upper portions of the module 1000 by workers, for example for maintenance or installation purposes. The ladders or staircases can may also facilitate access to another module, such as module 900 of FIG. 9, when the modules are in a stacked configuration. In some examples, the module 1000 can be 18.3 m in length, 4.9 m in width, 5.3 m in height, and 103.8 T in weight. In other examples, the module 1000 may have other dimensions or weights.

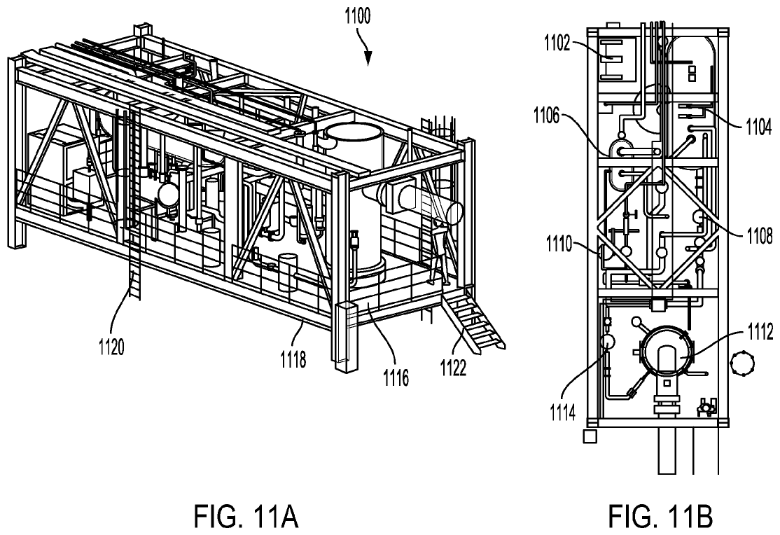

FIGS. 11A-B show two views of an example of an absorbent reclaiming module 1100 according to some aspects of the present disclosure. FIG. 11A shows a perspective view of the module 1100 and FIG. 11B shows a top-down view of the module 1000. The module 1100 can be configured to facilitate a process for reclaiming absorbent, for example by removing impurities from the amine solution used by the absorber. The module 1100 can include a junction box 1102, a degraded absorbent tank 1104, a thermal reclaimer reflux drum 1106, a degraded absorbent pump 1108, a thermal reclaimer reflux pump 1110, a thermal reclaimer tower 1112, and a thermal reclaimer bottom pump 1114. This equipment can be interconnected by piping prior to the module 1100 arriving at an installation site. In other examples, the module 1100 may include more, less, or different equipment than is shown.

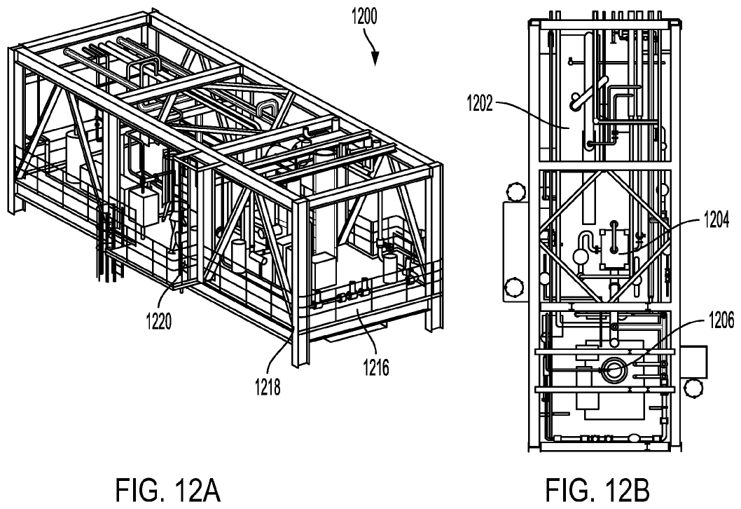

The equipment can be attached to a platform 1116 and/or surrounded by a structural support frame 1118, such as a steel structure. In some examples, the module 1100 may include one or more ladders, such as ladder 1120, and one or more staircases, such as staircase 1122. This can facilitate access to upper portions of the module 1100 by workers, for example for maintenance or installation purposes. The ladders or staircases can may also facilitate access to another module, such as module 1200 of FIG. 12, when the modules are in a stacked configuration. In some examples, the module 1100 can be 13.8 m in length, 4.9 m in width, 5.3 m in height, and 70.4 T in weight. In other examples, the module 1100 may have other dimensions or weights.

FIGS. 12A-B show two views of another example of an absorbent reclaiming module 1200 according to some aspects of the present disclosure. FIG. 12A shows a perspective view of the module 1200 and FIG. 12B shows a top-down view of the module 1200. The module 1200 can be configured to facilitate a process for reclaiming absorbent, for example by removing impurities from the amine solution used by the absorber. The module 1200 can include a thermal reclaimer vacuum package 1202, a thermal reclaimer reflux drum 1204, and a thermal reclaimer tower 1206. This equipment can be interconnected by piping prior to the module 1200 arriving at an installation site. In other examples, the module 1200 may include more, less, or different equipment than is shown.

The equipment can be attached to a platform 1216 and/or surrounded by a structural support frame 1218, such as a steel structure. In some examples, the module 1200 may include one or more ladders, such as ladder 1220, and one or more staircases. This can facilitate access to upper portions of the module 1200 by workers, for example for maintenance or installation purposes. The ladders or staircases can may also facilitate access to another module, such as module 1100 of FIG. 11, when the modules are in a stacked configuration. In some examples, the module 1200 can be 13.8 m in length, 4.9 m in width, 5.3 m in height, and 63.9 T in weight. In other examples, the module 1200 may have other dimensions or weights.

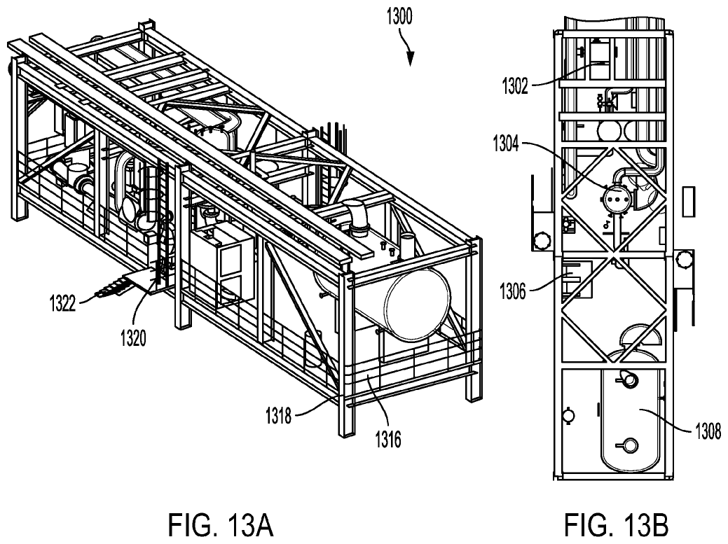

FIGS. 13A-B show two views of an example of an absorbent regeneration module 1300 according to some aspects of the present disclosure. FIG. 13A shows a perspective view of the module 1300 and FIG. 13B shows a top-down view of the module 1300. The module 1300 can be configured to facilitate a process for stripping CO₂ from absorbent and regenerating absorbent. The module 1300 can include a lean absorbent pump 1302, a CO₂ stripper reboiler condensate pot 1304, a junction box 1306, a CO₂ stripper reflux accumulator 1308, and a CO₂ stripper reflux pump 1310. This equipment can be interconnected by piping prior to the module 1300 arriving at an installation site. In other examples, the module 1300 may include more, less, or different equipment than is shown.

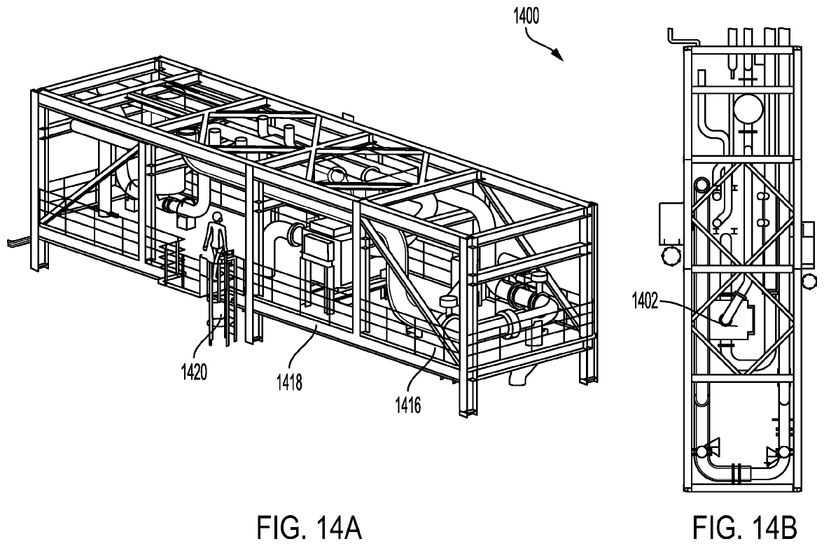

The equipment can be attached to a platform 1316 and/or surrounded by a structural support frame 1318, such as a steel structure. In some examples, the module 1300 may include one or more ladders, such as ladder 1320, and one or more staircases, such as staircase 1322. This can facilitate access to upper portions of the module 1300 by workers, for example for maintenance or installation purposes. The ladders or staircases can may also facilitate access to another module, such as module 1400 of FIG. 14, when the modules are in a stacked configuration. In some examples, the module 1300 can be 18.3 m in length, 4.9 m in width, 5.3 m in height, and 64.8 T in weight. In other examples, the module 1300 may have other dimensions or weights.

FIGS. 14A-B show two views of another example of an absorbent regeneration module 1400 according to some aspects of the present disclosure. FIG. 14A shows a perspective view of the module 1400 and FIG. 14B shows a top-down view of the module 1400. The module 1400 can be configured to facilitate a process for stripping CO₂ from absorbent and regenerating absorbent. The module 1400 can include a CO₂ stripper reflux accumulator 1402. This equipment can be interconnected to other equipment by piping prior to the module 1400 arriving at an installation site. In other examples, the module 1400 may include more, less, or different equipment than is shown.

The equipment can be attached to a platform 1416 and/or surrounded by a structural support frame 1418, such as a steel structure. In some examples, the module 1400 may include one or more ladders, such as ladder 1420, and one or more staircases. This can facilitate access to upper portions of the module 1400 by workers, for example for maintenance or installation purposes. The ladders or staircases can may also facilitate access to another module, such as module 1300 of FIG. 13, when the modules are in a stacked configuration. In some examples, the module 1400 can be 18.3 m in length, 4.9 m in width, 5.3 m in height, and 147.9 T in weight. In other examples, the module 1400 may have other dimensions or weights.

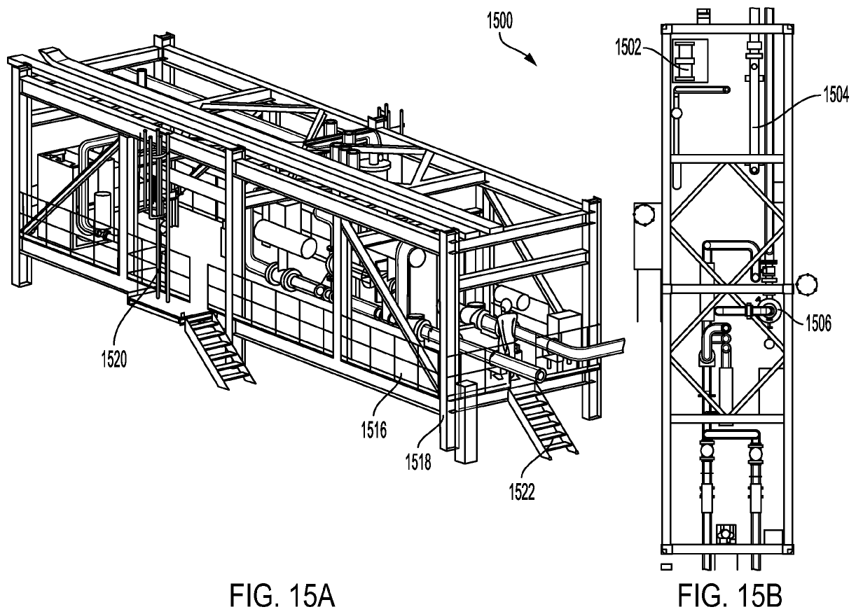

FIGS. 15A-B show two views of an example of a dehydration module 1500 according to some aspects of the present disclosure. FIG. 15A shows a perspective view of the module 1500 and FIG. 15B shows a top-down view of the module 1500. The module 1500 can be configured to facilitate a process for removing water from CO₂. The module 1500 can include a junction box 1502, a regeneration gas electric heater 1504, and a CO₂ dehydration knock-out drum 1506. This equipment can be interconnected prior to the module 1500 arriving at an installation site. In other examples, the module 1500 may include more, less, or different equipment than is shown.

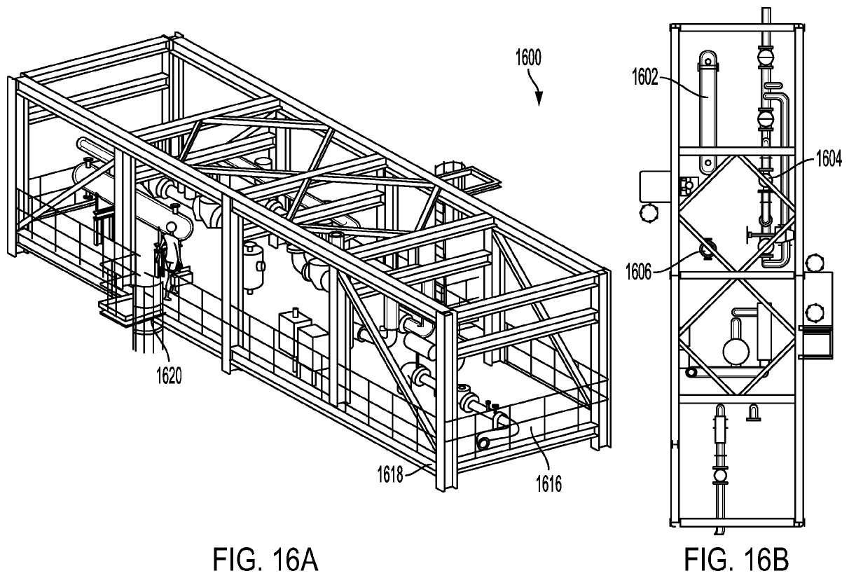

The equipment can be attached to a platform 1516 and/or surrounded by a structural support frame 1518, such as a steel structure. In some examples, the module 1500 may include one or more ladders, such as ladder 1520, and one or more staircases, such as staircase 1522. This can facilitate access to upper portions of the module 1500 by workers, for example for maintenance or installation purposes. The ladders or staircases can may also facilitate access to another module, such as module 1600 of FIG. 16, when the modules are in a stacked configuration. In some examples, the module 1500 can be 18.3 m in length, 4.9 m in width, 5.3 m in height, and 73.0 T in weight. In other examples, the module 1500 may have other dimensions or weights.

FIGS. 16A-B show two views of another example of a dehydration module 1600 according to some aspects of the present disclosure. FIG. 16A shows a perspective view of the module 1600 and FIG. 16B shows a top-down view of the module 1600. The module 1600 can be configured to facilitate a process for removing water from CO₂. The module 1600 can include a regeneration gas discharge cooler 1602, a regeneration gas discharge filter 1604, and a CO₂ dehydration filter 1606. This equipment can be interconnected prior to the module 1600 arriving at an installation site. In other examples, the module 1600 may include more, less, or different equipment than is shown.

The equipment can be attached to a platform 1616 and/or surrounded by a structural support frame 1618, such as a steel structure. In some examples, the module 1600 may include one or more ladders, such as ladder 1620, and one or more staircases. This can facilitate access to upper portions of the module 1600 by workers, for example for maintenance or installation purposes. The ladders or staircases can may also facilitate access to another module, such as module 1500 of FIG. 15, when the modules are in a stacked configuration. In some examples, the module 1600 can be 18.3 m in length, 4.9 m in width, 5.3 m in height, and 82.8 T in weight. In other examples, the module 1600 may have other dimensions or weights.

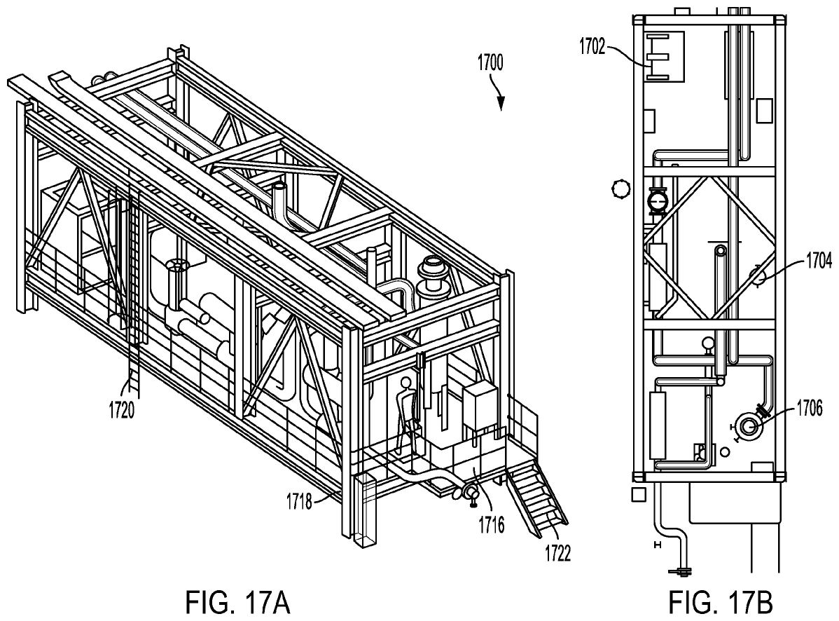

FIGS. 17A-B show two views of an example of a deoxygenation module 1700 according to some aspects of the present disclosure. FIG. 17A shows a perspective view of the module 1700 and FIG. 17B shows a top-down view of the module 1700. The module 1700 can be configured to facilitate a process for removing oxygen from CO₂. The module 1700 can include a junction box 1702, a process condensate return pump 1704, and a CO₂ high pressure (HP) compressor suction drum 1706. This equipment can be interconnected prior to the module 1700 arriving at an installation site. In other examples, the module 1700 may include more, less, or different equipment than is shown.

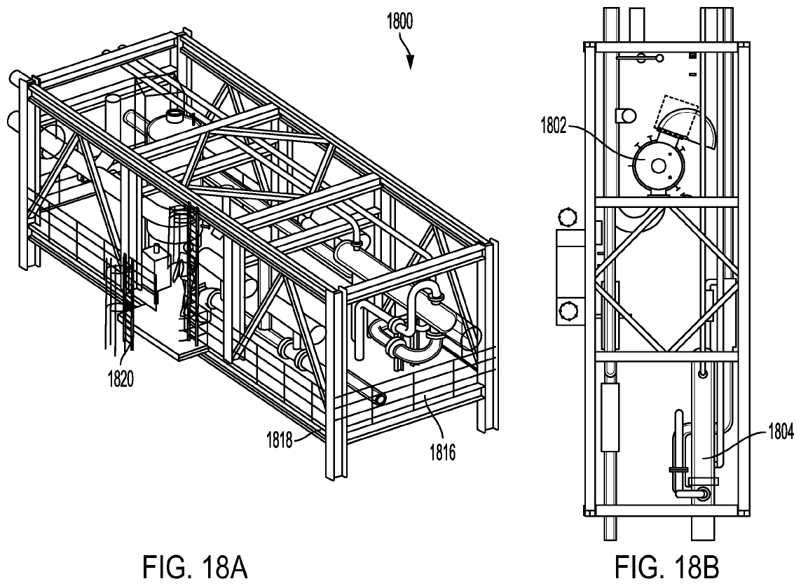

The equipment can be attached to a platform 1716 and/or surrounded by a structural support frame 1718, such as a steel structure. In some examples, the module 1700 may include one or more ladders, such as ladder 1720, and one or more staircases, such as staircase 1722. This can facilitate access to upper portions of the module 1700 by workers, for example for maintenance or installation purposes. The ladders or staircases can may also facilitate access to another module, such as module 1800 of FIG. 18, when the modules are in a stacked configuration. In some examples, the module 1700 can be 13.8 m in length, 4.9 m in width, 5.3 m in height, and 57.5 T in weight. In other examples, the module 1700 may have other dimensions or weights.

FIGS. 18A-B show two views of another example of a deoxygenation module 1800 according to some aspects of the present disclosure. FIG. 18A shows a perspective view of the module 1800 and FIG. 18B shows a top-down view of the module 1800. The module 1800 can be configured to facilitate a process for removing oxygen from CO₂. The module 1800 can include a CO₂ low pressure (LP) compressor suction drum 1802 and a reactor outlet cooler 1804. This equipment can be interconnected prior to the module 1800 arriving at an installation site. In other examples, the module 1800 may include more, less, or different equipment than is shown.

The equipment can be attached to a platform 1816 and/or surrounded by a structural support frame 1818, such as a steel structure. In some examples, the module 1800 may include one or more ladders, such as ladder 1820, and one or more staircases. This can facilitate access to upper portions of the module 1800 by workers, for example for maintenance or installation purposes. The ladders or staircases can may also facilitate access to another module, such as module 1700 of FIG. 17, when the modules are in a stacked configuration. In some examples, the module 1800 can be 13.8 m in length, 4.9 m in width, 5.3 m in height, and 45.1 T in weight. In other examples, the module 1800 may have other dimensions or weights.

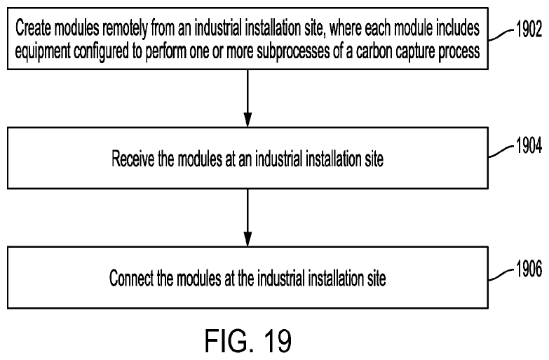

FIG. 19 shows a flowchart of an example of a process for deploying a modularized carbon-capture system according to some aspects of the present disclosure. The process can begin at block 1902, in which one or more manufacturing facilities create modules. The manufacturing facilities are remote from an industrial site at which the modules will be installed, also referred to herein as an industrial installation site. Thus, the modules can be created remotely from the industrial installation site at which they are to be installed. Each module can be configured to perform one or more subprocesses of a carbon capture process.

Each module can include a structural frame coupled a platform. The structural frame and platform can be sized to fit into a particular type of equipment bay at the industrial installation site. One or more pieces of equipment may be attached to the platform, the structural frame, or both. For example, the equipment can be bolted, welded, screwed, otherwise attached to the platform or the structural frame to affix the equipment in place on the module, so that it is safe for transport. After the equipment is attached to the module, the equipment can be interconnected by pipes (e.g., tubes). For example, the outlet of one piece of equipment can be connected to the inlet of another piece of equipment by a pipe, to establish a fluid communication pathway between the pieces of equipment. Stairs or ladders may also be attached to the modules to facilitate maintenance and access to the modules. For example, a ladder can be bolted to the structural frame to allow a worker to climb the vertical height of the module and thereby access equipment in the module or another module.

In block 1904, the modules are received at the industrial installation site. For example, the modules may be transported from the manufacturing facilities to the industrial installation site by trucks. The trucks may be oversized trucks, depending on the size and shape of the modules. After the trucks arrive at the industrial installation site, the modules can be unloaded from the trucks and positioned in place at the industrial installation site. In some examples, the modules may be removably bolted or removably welded to the beds of the trucks during transport to prevent them from moving, because such movement could be dangerous given the size and weight of the modules. Once at the installation site, the modules can be detached from the beds of the trucks and moved via a crane, forklift, or other lifting equipment to their final destination.

In block 1906, the modules are connected at the industrial installation site. The modules can be connected to each other, to other equipment of the carbon capture system, or both. For example, an outlet of one module may be connected to an inlet of another module to establish a fluid flow pathway between the modules, thereby forming a portion of the carbon capture system. In some examples, a single module may be connected to two or more other modules, to one or more other pieces of equipment (e.g., pieces of equipment that are not modularized), or both in the carbon capture system.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1-20. (canceled)

21. A system for capturing post-combustion carbon dioxide subsequent to an industrial process, the system comprising:
a plurality of prefabricated modules independently transportable to an industrial site, the plurality of prefabricated modules having equipment interconnectable at the industrial site to, in combination with site-erected equipment, collectively perform a carbon capture process;
wherein the system is configured to implement the following group of subprocesses for the carbon capture process:
a pre-scrubber subprocess for contaminant abatement and direct contact cooling for flue-gas quenching and saturation;
a flue gas pressurization subprocess for increasing a flue gas pressure for further processing in the system;
an absorption subprocess for extracting CO₂ from a flue gas by absorption of the CO₂ with an absorbent;
an absorbent reclaiming subprocess for removing a degraded absorbent and salts generated by flue gas contaminants;
an absorbent stripping subprocess for extracting saturated CO₂ gas from the absorbent;
a dehydration subprocess for drying the saturated CO₂ gas;
a compression subprocess for increasing a pressure of the saturated CO₂ gas or dry CO₂ gas for export or liquefaction; and
a liquefaction subprocess for liquifying gaseous CO₂;
wherein each module of the plurality of prefabricated modules includes equipment to implement a subprocess or a set of subprocesses selected from said group of subprocesses for the carbon capture process;
wherein each module of the plurality of prefabricated modules is individually replaceable and configured to interact other modules of the plurality of prefabricated modules, and has dedicated piping isolation, in which intra-equipment piping of each module is isolated from other piping of other modules and facilitates intra-module processes and interconnectedness with other modules;
wherein the system further comprises a processing device and each module includes one or more sensors that can communicatively couple to the processing device; and
wherein the processing device is configured to provide onsite or remote monitoring and control capability for operation of the equipment onboard each module based on a signal received from the sensor on the module.

22. The system of claim 21, wherein at least one of the subprocesses can be implemented by a combination of a prefabricated module and the site-erected equipment, the prefabricated module being one of the plurality of prefabricated modules.

23. The system of claim 21, wherein each module of the plurality of prefabricated modules is fabricated to have dimensions of no greater than 18.3 meters (m) in length and 4.9 m in width, to allow for road transportation of the plurality of prefabricated modules by truck.

24. The system of claim 21, wherein each module includes bottom and top structural frames connected by vertical posts and reinforcement beams, the bottom structural frame being used to support the equipment of the module.

25. The system of claim 21, wherein each module of the plurality of prefabricated modules is installed at the industrial site to form a linear configuration of a plurality of interconnected modules.

26. The system of claim 21, wherein each module of the plurality of prefabricated modules has a length that is an integer multiple of a predefined bay size, the plurality of prefabricated modules comprising a one-bay module, a two-bay module, a three-bay module, a four-bay module, or a combination of the foregoing.

27. The system of claim 21, wherein the plurality of prefabricated modules are vertically stackable to create a multi-level modular configuration.

28. A method comprising:
receiving, at an industrial site, a plurality of modules that were prefabricated remotely from the industrial site, wherein each module of the plurality of modules includes equipment configured to perform one or more subprocesses of a carbon capture process; and
installing the plurality of modules in a carbon capture system at the industrial site;
wherein the carbon capture process uses the following group of subprocesses:
a pre-scrubber subprocess for contaminant abatement and direct contact cooling for flue-gas quenching and saturation;
a flue gas pressurization subprocess for increasing a flue gas pressure for further processing in the system;
an absorption subprocess for extracting CO₂ from a flue gas by absorption of the CO₂ with an absorbent;
an absorbent reclaiming subprocess for removing a degraded absorbent and salts generated by flue gas contaminants;
an absorbent stripping subprocess for extracting saturated CO₂ gas from the absorbent;
a dehydration subprocess for drying the saturated CO₂ gas;
a compression subprocess for increasing a pressure of the saturated CO₂ gas or dry CO₂ gas for export or liquefaction; and
a liquefaction subprocess for liquifying gaseous CO₂;
wherein each module of the plurality of prefabricated modules includes equipment to implement a subprocess or a set of subprocesses selected from said group of subprocesses for the carbon capture process;
wherein each module of the plurality of prefabricated modules is individually replaceable and configured to interact other modules of the plurality of prefabricated modules, and has dedicated piping isolation, in which intra-equipment piping of each module is isolated from other piping of other modules and facilitates intra-module processes and interconnectedness with other modules;
wherein the system further comprises a processing device and each module includes one or more sensors that can communicatively couple to the processing device; and
wherein the processing device is configured to provide onsite or remote monitoring and control capability for operation of the equipment onboard each module based on a signal received from the sensor on the module.

29. The method of claim 28, wherein at least one of the subprocesses can be implemented by a combination of a module and site-erected equipment, the module being one of the plurality of modules.

30. The method of claim 28, further comprising receiving each module of the plurality of modules by vehicle at the industrial site.

31. The method of claim 28, further comprising:
receiving the plurality of modules from one or more manufacturing facilities that are remote from the industrial site; and
assembling the plurality of modules at the industrial site to create at least part of the carbon capture system.

32. The method of claim 28, wherein the plurality of modules are assembled at the industrial site by lifting from a road vehicle into allocated areas at the industrial site, and further comprising:
stacking at least one module of the plurality of modules on top of another module of the plurality of modules, to thereby create a multi-level modular configuration.

33. The method of claim 28, wherein the plurality of modules are interconnected via process pipework, electrical connections, instrumentation connections, and controls connections to form the carbon capture system at the industrial site.
